(19) United States
(12) Patent Application Publication
(10) Pub. No.: US 2012/0215959 A1
(43) Pub. Date: Aug. 23, 2012

(54) Cache Memory Controlling Method and Cache Memory System For Reducing Cache Latency

(76) Inventors: Seok-Il Kwon, Seoul (KR); Hoijin Lee, Seoul (KR)

(21) Appl. No.: 13/342,440

(22) Filed: Jan. 3, 2012

(30) Foreign Application Priority Data
Feb. 17, 2011 (KR) 10-2011-0014243

(51) Int. Cl. G06F 12/08

(52) U.S. Cl. 711/3; 711/118; 711/E12.017

(57) ABSTRACT

Disclosed is a cache memory controlling method for reducing cache latency. The method includes sending a target address to a tag memory storing tag data and sending the target address to a second group data memory that has a latency larger than that of a first group data memory. The method further includes generating and outputting a cache signal that indicates whether the first group data memory includes target data and that indicates whether the second group data memory includes target data. The target address is sent to the second group data memory before the output of the cache signal. With an exemplary embodiment, cache latency is minimized or reduced, and the performance of a cache memory system is improved.

### CROSS-REFERENCE TO RELATED APPLICATIONS

This application claims the benefits, under 35 U.S.C §119, to Korean Patent Application No. 10-2011-0014243 filed Feb. 17, 2011, the entirety of which is incorporated by reference herein.

### BACKGROUND

Exemplary embodiments relate to a cache memory system applied to a data processing device such as a computer system, and more particularly, relate to a cache memory controlling method capable of reducing cache latency and a cache memory system using the same.

Many data processing devices may include a processor that processes data read out from a main memory, such as a dynamic random access memory (DRAM). The data processing devices may include a cache memory system to reduce a potential bottleneck phenomenon during data processing due to a speed difference between the main memory and the processor.

A cache memory within the cache memory system may include an L1 (or level 1) cache or an L2 (or level 2) cache within a device. The L1 cache known as a primary cache may be accessed first by the processor and its memory capacity may be less in size than the L2 cache. As micro architecture becomes more complicated and increased operating speed and power is an issue, an increase in a memory capacity of the L1 and L2 caches may be desirable. However, current chip design may increase the latency of cache memories.

### SUMMARY

In an exemplary embodiment, a cache memory controlling method for reducing cache latency comprises the steps of: receiving, by a first memory storing tag data, a target address; generating and outputting a cache signal based on the target address, the cache signal including indicating whether a first group data memory stores a target data and indicating whether a second group data memory stores the target data; receiving the target address at the second group data memory before the cache signal is output, and outputting to a first line, by the second group data memory, a second target data based on the target address, wherein the second group data memory has a latency larger than that of the first group data memory.

In an exemplary embodiment, a cache memory system comprises: a cache memory comprising at least a first group data memory, at least a second group data memory, and a switch configured to receive a second group target data from the second group data memory and to control whether to output the second target data to an output line based on a cache signal; and a cache controller configured to: compare a target address to tag data; and generate the cache signal indicating whether the first group data memory stores a target data corresponding to the target address and indicating whether the second group data memory stores the target data.

In an exemplary embodiment, a method for reducing cache latency in a cache memory, comprises the steps of: receiving, by a first memory, a target address; generating and outputting a cache signal based on the target address, the cache signal indicating whether a first group data memory includes a target data corresponding to the target address and indicating whether a second group data memory includes the target data; receiving the target address at a second group data memory before the cache signal is output; and outputting to a first line, by the second group data memory, a second target data based on the target address, wherein the second group data memory is situated farther from a cache controller than the first group data memory.

### BRIEF DESCRIPTION OF THE FIGURES

The above and other objects and features of the disclosure will become more apparent by describing in detail exemplary embodiments thereof with reference to the attached drawings, in which:

FIG. 1 is a block diagram of a data processing device according to an exemplary embodiment;

FIG. 2 is a layout diagram showing a layout of a cache memory system in FIG. 1;

FIG. 3 is a block diagram of an exemplary cache memory system according to a first embodiment;

FIG. 4 is a flowchart of an exemplary operation of a cache memory system according to the first embodiment;

FIG. 5 is a block diagram of a cache memory system according to another exemplary embodiment;

FIG. 6 is a flowchart of an exemplary operation of a cache memory system according to another exemplary embodiment;

FIG. 7 is a block diagram of the second/third group data memory in FIG. 3 or 4 according to an exemplary embodiment;

FIG. 8 is a block diagram of the second/third group data memory in FIG. 3 or 4 according to another exemplary embodiment;

FIG. 9 is a block diagram of an electronic system according to an exemplary embodiment;

FIG. 10 is a block diagram of a data processing device according to an exemplary embodiment; and

FIG. 11 is a block diagram of a memory card according to an exemplary embodiment.

### DETAILED DESCRIPTION

The present disclosure will now be described more fully below with reference to the accompanying drawings, in which various embodiments are shown. This invention may, however, be embodied in many different forms and should not be construed as limited to the embodiments set forth herein. In the drawings, the size and relative sizes of layers and regions may be exaggerated for clarity. Like numbers refer to like elements throughout.

It will be understood that, although the terms first, second, third etc. may be used herein to describe various elements, components, regions, layers and/or sections, these elements, components, regions, layers and/or sections should not be limited by these terms. Unless indicated otherwise, these terms are only used to distinguish one element, component, region, layer or section from another region, layer or section. Thus, a first element, component, region, layer or section discussed below could be termed a second element, component, region, layer or section, and, similarly, a second element, component, region, layer or section discussed below could be termed a first element, component, region, layer or section without departing from the teachings of the disclosure.

Locational terms, such as “beneath”, “below”, “lower”, “under”, “above”, “upper” and the like, may be used herein for ease of description to describe one element's or feature's relationship to another element(s) or feature(s) as illustrated in the figures. It will be understood that the locational terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the term “below” can encompass both an orientation of above and below. The device may be otherwise oriented (rotated 90 degrees or at other orientations) and the locational descriptors used herein should be interpreted accordingly. In addition, it will also be understood that when a layer or an element is referred to as being “between” two layers or elements, it can be the only layer or element between the two layers or elements, or one or more intervening layers or elements may also be present.

The terminology used herein is for the purpose of describing particular embodiments only and is not intended to be limiting of the invention. As used herein, the singular forms “a”, “an” and “the” should not exclude the plural forms as well, unless the context clearly indicates otherwise. It will be further understood that the terms “comprises” and/or “comprising” and “includes” and/or “including” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

It will be understood that when an element or layer is referred to as being “on” or “connected to”, “coupled to”, or “adjacent to” another element or layer, it can be directly on or connected, coupled, or adjacent to the other element or layer, or intervening elements or layers may be present. In contrast, when an element is referred to as being “in contact” or “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

A cache memory system may include one or more cache memories. A cache memory is a temporal storage device that is widely used on the basis of its data access characteristics of locality and repeatability. For example, a cache memory may store data that is accessed often from the main memory, and may have a faster operating speed than a main memory. It may also be integrated with a processor or may be closer to the processor than a main memory, making the data access more efficient.

A cache memory within a cache memory system may be used as an L1 (or level 1) cache or an L2 (or level 2) cache. The L1 cache, also known as a primary cache, may be accessed first by the processor and its memory capacity may be less in size than the L2 cache. The L2 cache, also called a secondary cache, may be accessed second by the processor when the processor does not find its desired data in the L1 cache. An operating speed of the L2 cache may be slower than the L1 cache and faster than the main memory. In some microprocessors, an L2 cache may store pre-fetched data and may be used to buffer program instructions and data that the processor is about to request from the main memory (i.e. during streaming data access).

Latency may represent a waiting time from a point of time when an address for accessing a cache memory is sent to the cache memory to a point of time when cache hit data is received. The latency may be also called a latency cycle. The time cycle of latency is not limited to the example described herein. In one embodiment, cache memory access time may represent a waiting time from a point of time when an address for accessing data is sent to a cache memory system including one or more group data memories to a point of time when data is output from the cache memory system. The cache memory system may have a cache memory access time that corresponds to the processing time of the entire system. Similarly, a group data memory within a cache memory system may have its own cache memory access time that represents a waiting time corresponding to that specific group data memory. In one embodiment, the waiting time that corresponds to the processing of a single group data memory within a cache memory system is described as the latency for that single group data memory, while the cache memory access time corresponds to the overall waiting time of the cache memory system.

In one embodiment, the cache memory system is a cache memory system in a CPU. When a processor wants to access data in the main memory, the processor may first access the cache memory system to determine if the data is in the cache memory system. The cache memory system may receive a physical address from the processor, where the physical address corresponds to a memory index in the main memory at which the requested data is stored. The cache memory system may include a tag memory that stores a tag entry for each piece of data that the cache memory stores. Each tag entry may be stored in a table and may contain a cache address in the cache memory system where data is stored and the corresponding physical address in the main memory in which the data would be stored. In an embodiment where the cache memory system is not located in a CPU with a main memory, the tag stored in the tag memory may include a cache address and a physical address corresponding to a memory index in the memory with which the cache is associated. In one embodiment, each group data memory in a cache memory system includes the tag memory. In one embodiment, the cache memory system includes a tag memory separate from any group data memory.

In one embodiment, the cache memory system may also include logic that determines if the cache memory system contains data corresponding to an address that the cache memory receives from a processor. That logic may be embedded with the tag memory or may be part of a separate comparing and converting part of the cache memory system. In one embodiment, the comparing and converting part (or the corresponding logic) would determine if the cache memory system, or a cache memory within the cache memory system, includes the data corresponding to an address received by the cache memory system. In response, the comparing and converting part (or corresponding logic) may generate a cache hit/miss signal which it would send to each cache memory within the cache memory system. In one embodiment, a data group memory in the cache memory system includes the logic. In this embodiment, the data group memory includes the logic as part of the tag memory or as a component separate from the tag memory. In one embodiment, the cache memory system may include a tag memory and a comparing and converting part that are separate from the cache memories in the cache memory system.

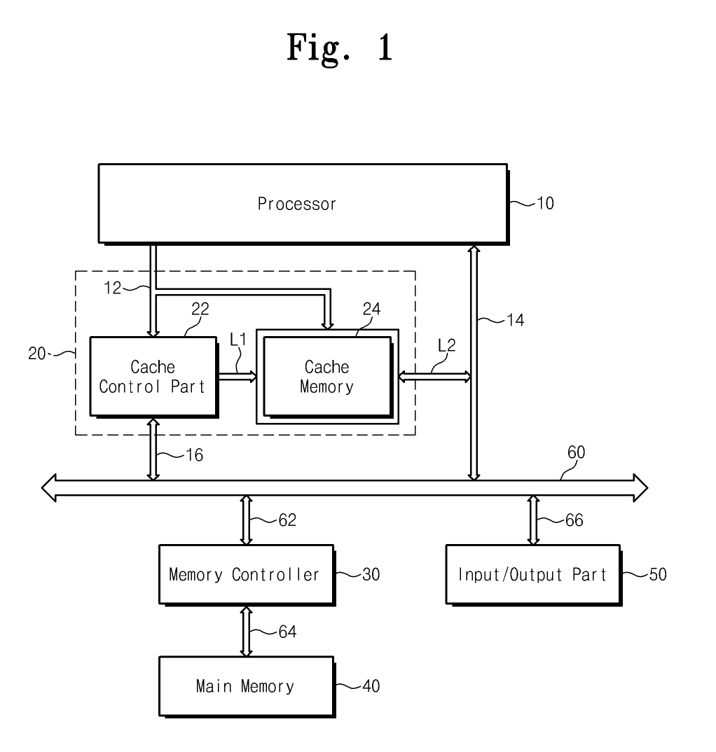

FIG. 1 is a block diagram of a data processing device according to an exemplary embodiment.

Referring to FIG. 1, a data processing device may include a processor 10, a cache memory system 20, a memory controller 30, and a main memory 40.

The cache memory system 20 may include a cache control part 22 and a cache memory 24. In an exemplary embodiment, the cache memory 24 may be an L2 (or level 2) cache.

A system bus 60 may be connected to a line 16 of the cache control part 22 and a data line 14 of the processor 10. The cache control part 22 may be, for example, a cache controller that provides instructions to control a cache memory.

The memory controller 30, connected to the system bus 60 via a line 62, may control the main memory 40 according to a command of the processor 10. The system bus 60 may be connected to an input/output part 50 that performs a data input/output operation via a line 66.

During an exemplary data processing operation, the processor 10 may first access the cache memory 24 prior to accessing the main memory 40. In this case, an address and a control command may be sent to the cache control part 22 and the cache memory 24 via a line 12. If the cache memory 24 includes data or commands demanded by the processor 10, the cache control part 22 may indicate that a cache hit has occurred. As a result of the cache hit, target data from the cache memory 24 may be transferred to the processor 10 via a line L2 and the data line 14.

As described above, the processor 10 may first access the cache memory 24 instead of first accessing the main memory 40. The processor 10 may access the cache memory 24 first because the cache memory 24 stores frequently accessed portions of data from the main memory 40. The cache memory system 20 may include a tag memory that stores tag entries for all of the data it stores. As discussed above, a tag entry may include both tag data that indicates an address of target data stored within the cache memory 24 as well as a physical address corresponding to where the data would be stored in the main memory 40. When the cache memory system 20 receives a physical address from the processor 10, it may use the tag data in the tag memory to determine if the cache memory 24 includes the data that the processor 10 wants to access. In one embodiment, the tag entry also includes a data locator, which indicates which group data memory in the cache memory 24 stores the data requested by the processor 10. In this embodiment, the tag data would include the data locator.

If data or commands requested by the processor 10 are not stored in the cache memory 24, the cache control part 22 may indicate that a cache miss has occurred. As a result of the cache miss, the processor 10 may control the memory controller 30 via the system bus 60 to access the main memory 40, and data from the main memory 40 may be transferred to the data line 14 via the system bus 60.

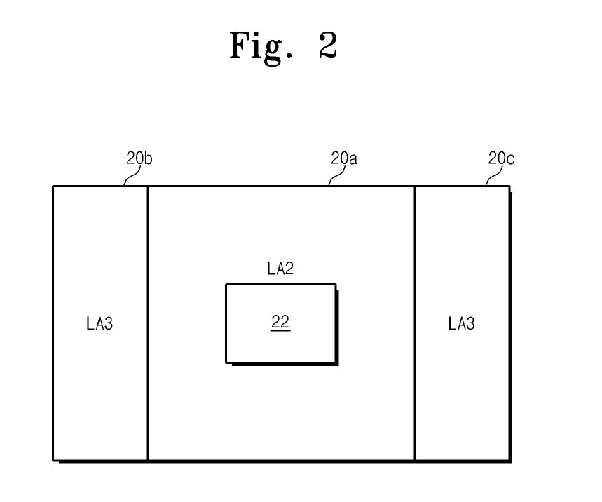

FIG. 2 is a layout diagram showing an exemplary layout of a cache memory system in FIG. 1.

Referring to FIG. 2, a cache control part 22 includes a logic region that determines if data associated with an address is present in the cache memory 24. The logic region may be disposed at a center area 20a. In one embodiment, the logic region communicates with the tag memory to determine if data associated with an address is stored in the cache memory 24. In one embodiment, the cache memory 24 includes one or more data memories that may be disposed at the center area 20a and at peripheral areas 20b and 20c. The data memories disposed at the center area 20a may be physically closer to the cache control part 22 as compared with the data memories disposed at the peripheral areas 20b and 20c. Given their closer location to the cache control part 22, the data memories disposed at the center area 20a may have a smaller latency than the data memories disposed at the peripheral areas 20b and 20c. For example, the data memories disposed at the center area 20a may have a latency 2 (LA2) as a memory waiting time, and the data memories disposed at the peripheral areas 20b and 20c may have latency 3 (LA3). In one embodiment, a cache memory with a latency of 3 may take one more time cycle to determine and return a result of whether a cache hit or cache miss has occurred than a cache memory with a latency of 2. As mentioned above, the measurement of latency may depend on different actions or results regarding cache access. For example, latency may be measured to be the amount of time a cache memory uses to return a cache hit or cache miss after it receives an address from a processor. In another example, latency may be measured to be the amount of time a cache memory uses to return data in response to a request from a processor. The results or actions used to determine cache latency are not limited to the examples described herein.

In one embodiment, if data memories are disposed at the peripheral areas 20b and 20c to increase a memory capacity of an L2 cache, the cache memory access time of the L2 cache may inevitably increase because it will take more time to search the data memories to determine if a cache hit or a cache miss has occurred. Cache memory access time and latency often correlate with cache memory capacity. As mentioned above, in some embodiments, cache memory access time describes the amount of time it takes a cache memory system (that includes one or more group data memories) to output data after it receives an address from a processor, while latency describes the waiting time for a group data memory to output data after the cache memory receives an address from a processor. As cache memory capacity increases, cache memory access time and latency may also increase. The performance of a larger cache memory is often not as good as the performance of a smaller cache memory.

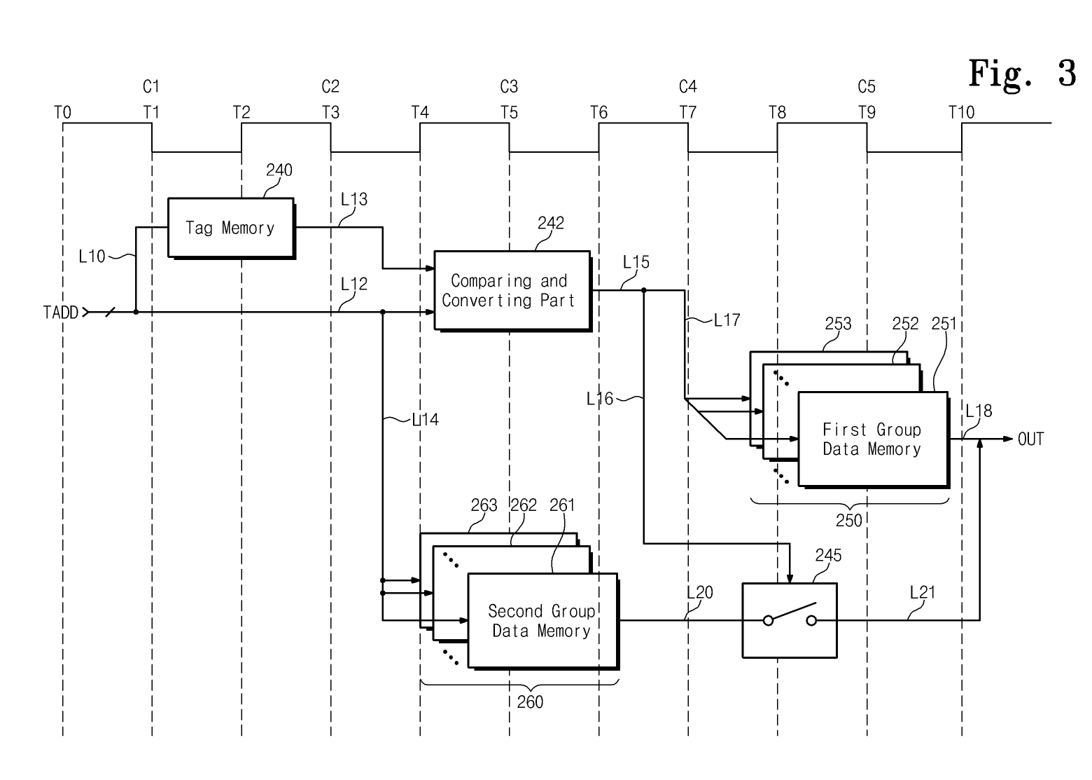

In an exemplary embodiment, a memory access time of a cache may be variable if the cache includes multiple data memories, each with their own latency. For example, the cache memory in FIG. 2 may have a latency of 3 (LA3), even though one or more data memories in the cache memory of FIG. 2 have a latency of 2 (LA2). The cache memory access time may be slowed by the addition of data memories that are necessarily spaced further away from the cache control part 22 than the initial data memory. In one embodiment, the cache memory 20 of FIG. 2 has a cache memory access time of 3 (LA3), although data memories having the latency 2 LA2 exist in the cache memory. In this embodiment, the cache memory access time of the cache memory 20 is higher due to the disposition of data memories at the peripheral areas 20b and 20c. In one embodiment, the cache memory access time of the cache memory may be determined by a latency value of a data memory with the farthest path to the cache control part. For example, the data memories disposed at the center area 20a may have a latency value LA1 (LA1=LA3−LA2) as their latency. As illustrated in FIG. 3, data memories may be grouped according to a physical distance. As such, the latency of the grouped data memories and applying times of tag addresses may be differentiated. Thus, it is possible to reduce redundancy latency (e.g. the latency due to repeated accesses of data memories in a cache memory) on data memories disposed at the center area 20a.

FIG. 3 is a block diagram of a cache memory system according to one embodiment. Referring to FIG. 3, a cache memory system may include a tag memory 240, a comparing and converting part 242, the first group data memory 250, the second group data memory 260, and a switch 245.

A cache memory 24 in FIG. 1 may include a tag memory 240 for storing tag entries related to cache data stored in the cache data memory. As mentioned above, in one embodiment, a tag entry may include both tag data that indicates an address of target data stored within the cache memory 24 as well as a physical address corresponding to where the data would be stored in the main memory 40. When the cache memory 24 receives a physical address from the processor 10, it may use the tag data in the tag memory to determine if the cache memory 24 includes the cache data (the data that the processor 10 wants to access). In one embodiment, the tag entry also includes a data locator, which indicates which group data memory in the cache memory 24 stores the data requested by the processor 10. In this embodiment, the tag data includes the data locator.

The cache memory 24 may also include the first group data memory 250 for storing target data, and the second group data memory 260 for storing target data. In this example, the latency of the second group data memory 260 may be larger than that of the first group data memory 250. For example, when the second group data memory 260 has the latency 3 (LA3) described in FIG. 2, the first group data memory 250 may have the latency 2 (LA2). In one embodiment, the second group data memory 260 may be disposed farther from the cache control part 22 than the first group data memory 250. In one embodiment, the first and second group data memories 250 and 260 may be formed of a plurality of data memory arrays. The data memory arrays may each be formed of a memory bank or a memory mat or other suitable memory structures not described herein.

The cache control part 22 in FIG. 1 may include various control logics for performing a cache operation. For ease of depiction, not all of the control logics may be illustrated in FIG. 3 or described herein. A cache control part 22 is not limited to those control logics described herein. In FIG. 3, the comparing and converting part 242 is illustrated as a part of the cache control part 22. In one embodiment, the comparing and converting part 242 may be used in tandem with the tag memory 240. In one embodiment, the comparing and converting part 242 may be a part of the processing functionality of the tag memory 240. The comparing and converting part 242 may receive tag data and a target address TADD from the tag memory 240 and may perform a judging operation using the tag data and target address TADD. In one embodiment, the tag data includes a cache address at which the requested data is stored as well as a data locator which indicates which data memory stores the requested data.

In one embodiment, the judging operation determines whether the cache memory contains the requested data. In one embodiment, the judging operation determines which of the group data memories that comprise the cache memory contains the requested data (if any do). In one embodiment, the judging operation uses the data locator to determine which of the group data memories stores the requested data. In one embodiment, the comparing and converting part 242 communicates with the tag memory 240 to perform the judging operation. In one embodiment, the comparing and converting part 242 includes a comparing table (not shown) with entries for all of the data stored in the cache memory 24. In this embodiment, the comparing table includes, for each data stored in the cache memory 24, the address of the data in the cache and which group data memory stores the data. In this embodiment, the comparing and converting part 242 accesses its comparing table when performing the judging operation.

The comparing and converting part 242 may generate a cache hit/miss signal as the judging result that it sends either directly to each group data memory or to a corresponding switch that controls whether data is output from a group data memory. In one embodiment, the cache hit/miss signal comprises cache information for each group data memory in the cache memory. In one embodiment, the cache hit/miss signal includes an indicator that indicates whether the first group data memory 250 contains the requested data (i.e. whether there is a cache hit at the first group data memory 250) and an indicator that indicates whether the second group data memory 260 stores the requested data (i.e. whether there is a cache hit at the second group data memory 260). In one embodiment, the cache hit/miss signal comprises a set of bits. For example, the number of bits in the cache hit/miss signal may correspond to the number of data groups in the cache memory. In this embodiment, a cache hit for a group data memory is indicated by setting the bit corresponding to that group data memory to 1, and setting the remaining bits in the cache hit/miss signal to 0. In one embodiment, the cache information is represented by one bit.

However, other types of indicators and information may be used in the cache hit/miss signal to indicate cache hits and/or misses in the group data memories. In one embodiment, the comparing and converting part 242 generates a separate cache hit or cache miss signal (as appropriate) for each group data memory that comprise the cache memory as the judging result. For the embodiments described above, the comparing and converting part 242 may send a cache hit or cache miss signal (as appropriate) either directly to each group data memory or to a switch corresponding to a group data memory that controls whether data is output from that group data memory.

In one embodiment, the cache control part 22 sends the target address TADD to the tag memory 240 and the second group data memory 260. In one embodiment, the cache control part 22 does not send the target address TADD to the first group data memory 250. Instead, the comparing and converting part 242 may send the target address TADD to the first group data memory 250. The target address TADD may be sent to the tag memory 240 via a line L10 and to the second group data memory 260 via lines L12 and L14, respectively. The tag memory 240 may output tag data via a line L13 in response to the target address TADD.

In one embodiment, the cache control part 22 may send a waiting time to the tag memory 240 and the second group data memory 260 along with the target address TADD. In this embodiment, the waiting time represents the amount of time that the comparing and converting part 242 should wait until sending a cache hit/miss signal in response to receiving tag data from the tag memory 240. The waiting time may correspond to the latency of the second group data memory 260. In one embodiment, the waiting time enables the second group data memory 260 to finish processing the target address and output target data in response to the target address TADD around the same time that the comparing and converting part 242 sends out a cache hit/miss signal for the data corresponding to the target address TADD. In this embodiment, the switch 245 remains open when the second group data memory 260 processes the target address TADD and outputs target data. When the switch 245 receives the cache hit/miss signal from the comparing and converting part 242, the data on the line L20 (the target data output from the second group data memory 260) will be the data that corresponds to the same target address TADD for which the cache hit/miss signal was generated. In this embodiment, if there is a cache hit at the second group data memory 260, switch 245 closes at the appropriate time such that the correct target data will be output to line L21.

In one embodiment, the comparing and converting part 242 outputs a cache hit/miss signal and a target address TADD on the line L15. In addition, the first group data memory 250 may receive the target address TADD and the cache hit/miss signal from the comparing and converting part 242 via a line L17 which is connected with a line L15. The cache hit/miss signal and the target address TADD may be received by the first group data memory 250 via a line L17 and by the switch 245 via a line L16 as a switching control signal.

In one embodiment, the second group data memory 260 outputs target data on line L20 in response to receiving the target address TADD. The switch 245 may remain open until it receives a cache hit/miss signal from the comparing and converting part 242 that indicates a cache hit at the second group data memory 260. If there is a cache hit at the second group data memory 260, the switch may close and the target data output from the second group data memory 260 is sent into an output terminal OUT via a line L21. In one embodiment, after the target data is sent, the switch automatically opens and remains in an open state until another cache hit/miss signal received from the comparing and converting part 242 indicates a cache hit at the second group data memory 260. If the cache hit/miss signal received at the switch 245 indicates a cache miss at the second group data memory 260, the switch 245 remains in an open state and the target data output on line L20 from the second group data memory 260 is not output via the output terminal OUT.

In one embodiment, the first group data memory 250 receives the cache hit/miss signal and the target address TADD. If the cache hit/miss signal indicates a cache hit at the first group data memory 250, then the first group data memory 250 processes the target address TADD and outputs target data corresponding to the target address TADD. In this embodiment, the first group data memory 250 sends the target data into an output terminal OUT via a line L18. However, if the cache hit/miss signal indicates a cache miss at the first group data memory 250, then the first group data memory 250 does not process the target address TADD and no data is output from the first group data memory via line L18. In one embodiment, the output terminal OUT connects with the line L2 to send data to a data line L14 which connects to the bus 60 and the processor 10 of the data processing device. In this embodiment, the target data output from the cache memory 24 is sent to the processor 10 via line L2 and the data line L14 in response to receiving a target address TADD.

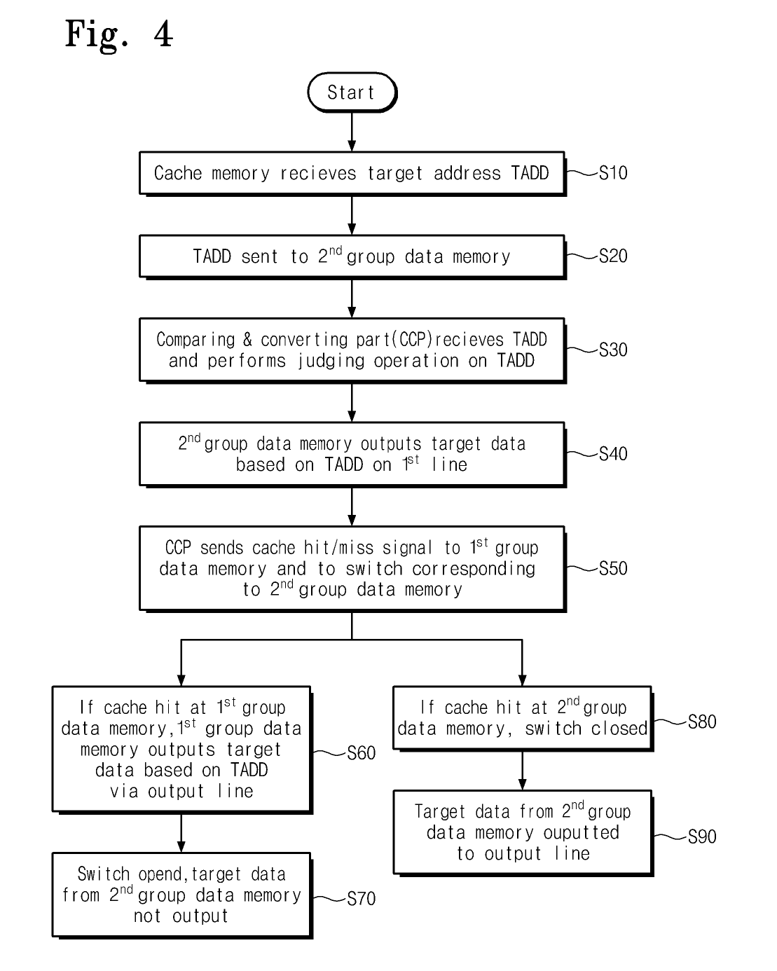

FIG. 4 is a flowchart illustrating an exemplary operation of the cache memory system of FIG. 3. In step S10, the cache memory receives the target address TADD. In step S20, the cache control part 22 sends the TADD to the tag memory 240 and the second group data memory 260. In step S30, the comparing and converting part 242 receives the TADD and performs a judging operation on the TADD. In step S40, the second group data memory 260 outputs target data based on the TADD on line L20. In one embodiment, steps S30 and S40 may be performed concurrently, or step S40 may be performed before or after step S30. In step S50, the comparing and converting part 242 sends a cache hit/miss signal on lines L15 and L17 to the first group data memory 250 and on lines L15 and L16 to a switch 245 corresponding to the second group data memory 260. In step S60, if the cache hit/miss signal indicates a cache hit at the first group data memory 250, the first group data memory 250 outputs target data based on the TADD to the output terminal OUT. In step S70, the switch 245 receives the cache hit/miss signal and the switch 245 remains open so that the second group data memory 260 is not connected to the output terminal OUT and the target data output by the second group data memory 260 to line L20 is not output to the output terminal OUT. In one embodiment, steps S60 and S70 may be performed concurrently or step S60 may be performed before or after step S70. If the cache hit/miss signal indicates a cache miss at the first group data memory 250, the first group data memory 250 does not output target data based on the TADD (not shown). In step S80, if the cache hit/miss signal indicates a cache hit for the second group data memory 260, the switch 245 is closed. In step S90, the target data output by the second group data memory 260 is output to the output terminal OUT.

Referring to FIG. 3, 5 latency cycles C1 to C5 are illustrated as a waveform of a cycle signal CS. One cycle may correspond to a system clock frequency signal or to a plurality of clock frequency signals. In one embodiment, and as shown in FIG. 3, the cache memory may apply a target address TADD to each of the group data memories 250 and 260 such that the processing of each group data memory 250 and 260 is finished and target data is output at the same time (e.g. during the same clock cycle). For example, if the latency of the first group data memory 250 is 2 clock cycles and the latency of the second group data memory 260 is 3 clock cycles, the target address TADD may be applied to the second group data memory 260 one clock cycle before it is applied to the first group data memory 250. In one embodiment, the target address TADD is applied to the second group data memory 260 one or more clock cycles earlier than it would need to be applied for the processing of the first group data memory 250 in order for the target data to be output at the same time.

In the embodiment depicted in FIG. 3, the first group data memory 250 may have a latency of 2 and the second group data memory 260 may have a latency of 3. In this embodiment, a target address TADD is received by the first group data memory 250 at t8. In an exemplary cache memory system, the target address TADD is applied to the second group data memory 260 before the first group data memory 250. At t4, the target address TADD may be received by the second group data memory 260. As mentioned above, the target address TADD is applied to the second group data memory 260 at an early enough time such that its processing is able to end at the same time or before the processing of the first group data memory 250. In one embodiment, the cache memory access time of the cache memory system may be adjusted to be close to a latency value of the first group data memory 250. In one embodiment, the cache memory access time of the cache memory system may be reduced. For example, the cache memory access time of the cache memory system 20 may be reduced to be similar to a latency of a cache memory system that only included the first group data memory 250.

The architecture of the cache memory system in FIG. 1 may be utilized more powerfully in the event that a value of a cache memory access time and a latency value are different according to physical placements of data memories and an access time of a tag memory has latency over at least one or more cycles.

Latency of the first group data memory 250 may be relatively small since it is disposed to be closer to a logic area of a cache control part. For this reason, the first group data memory 250 may be grouped to a short-distance cache data memory group. The short-distance cache data memory group may include one or more data memories that are disposed to be closer to a logic area of the cache control part. In one embodiment, target data from a short-distance cache data memory is obtained after generation and/or output of a cache hit/miss signal.

Latency of the second group data memory 260 may be relatively large since it is disposed farther from a logic area of a cache control part. For this reason, the second group data memory 260 may be grouped to a long-distance cache data memory group. The long-distance cache data memory group may include one or more data memories that are disposed to be farther from a logic area of the cache control part. In one embodiment, target data from a long-distance cache data memory is obtained by applying a target address TADD to the long-distance cache data memories before the generation and/or output of a cache hit/miss signal. The target data may be output at a cycle where power dissipation is minimized.

The cache memory access time of the cache memory system may be minimized or reduced by sending a target address to the second group data memory 260, which has a latency larger in value than that of the first group data memory 250, before the generation and/or output of a cache hit/miss signal, and switching target data output from the second group data memory 260 according to the cache hit/miss signal. This exemplary operation may enable high-speed cache operation and may improve the performance of the cache memory system.

The cache memory system of FIG. 3 may prevent an increase in the latency of a cache memory system even if the memory capacity of that cache memory system is increased. In one embodiment, the cache memory system may be suitable for an L2 cache of a computer system or a data processing device.

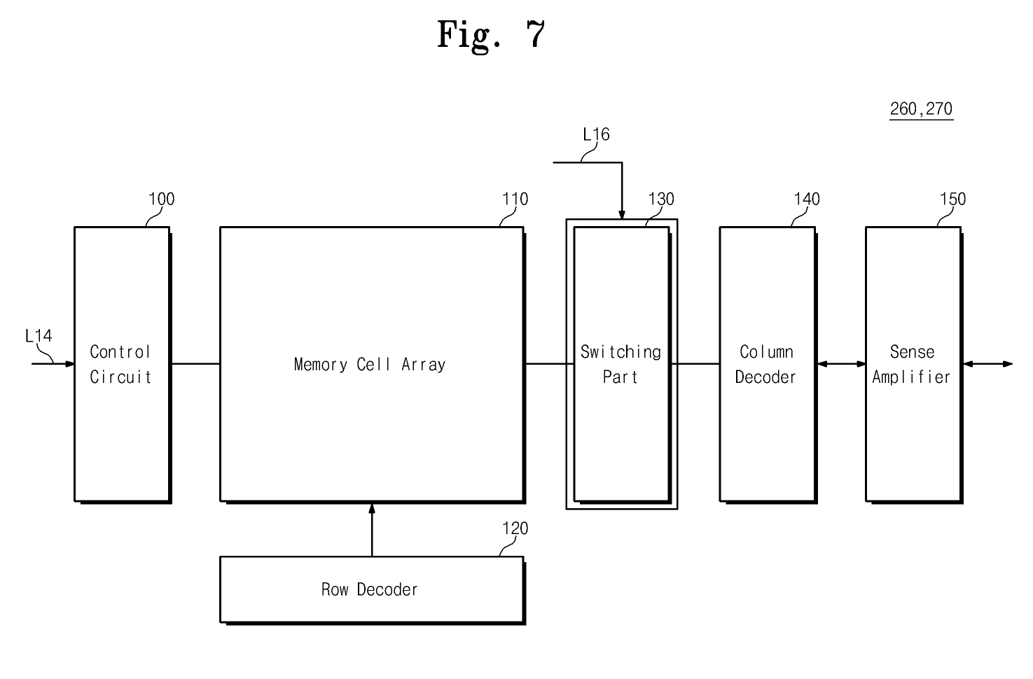

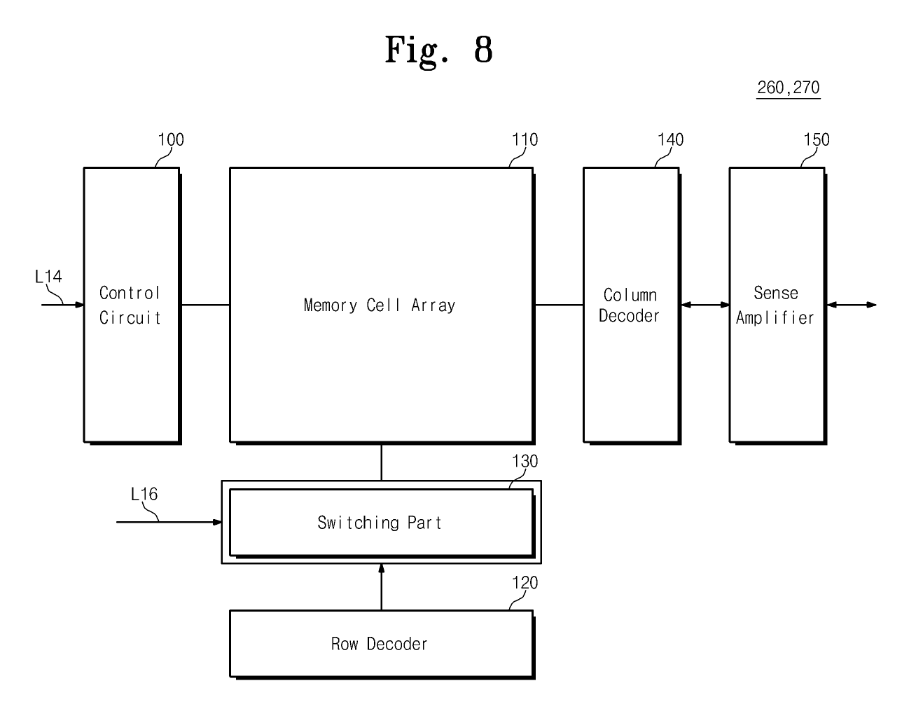

In FIG. 3, an example configuration of the cache memory depicts the switch 245 being installed outside of the second group data memory 260. As illustrated in FIGS. 7 and 8, the switch 245 can be replaced with a switching part 130 installed within the second group data memory 260. In one embodiment, the switch 245 may be used to prevent a logic malfunction such as having target data output on the line L20 when target data is output on the line L18. The use of the switch 245 allows the output of target data from both the first and second group data memories 250 and 260 when a cache memory is accessed according to a target address TADD. As a result, when a cache hit/miss signal is generated and the first group data memory 250 outputs target data, an output of the line L21 may be blocked.

As illustrated in FIG. 7, the switching part 130 for switching target data may be placed between a memory cell array 110 and a column decoder 140 of the second group data memory 260. As illustrated in FIG. 8, the switching part 130 for switching target data may be placed between a memory cell array 110 and a row decoder 120 of the second group data memory 260.

In a case where a cache memory capacity increases, a cache memory system in FIG. 3 may further include a third group data memory 270 with a latency that is larger than that of the second group data memory 260.

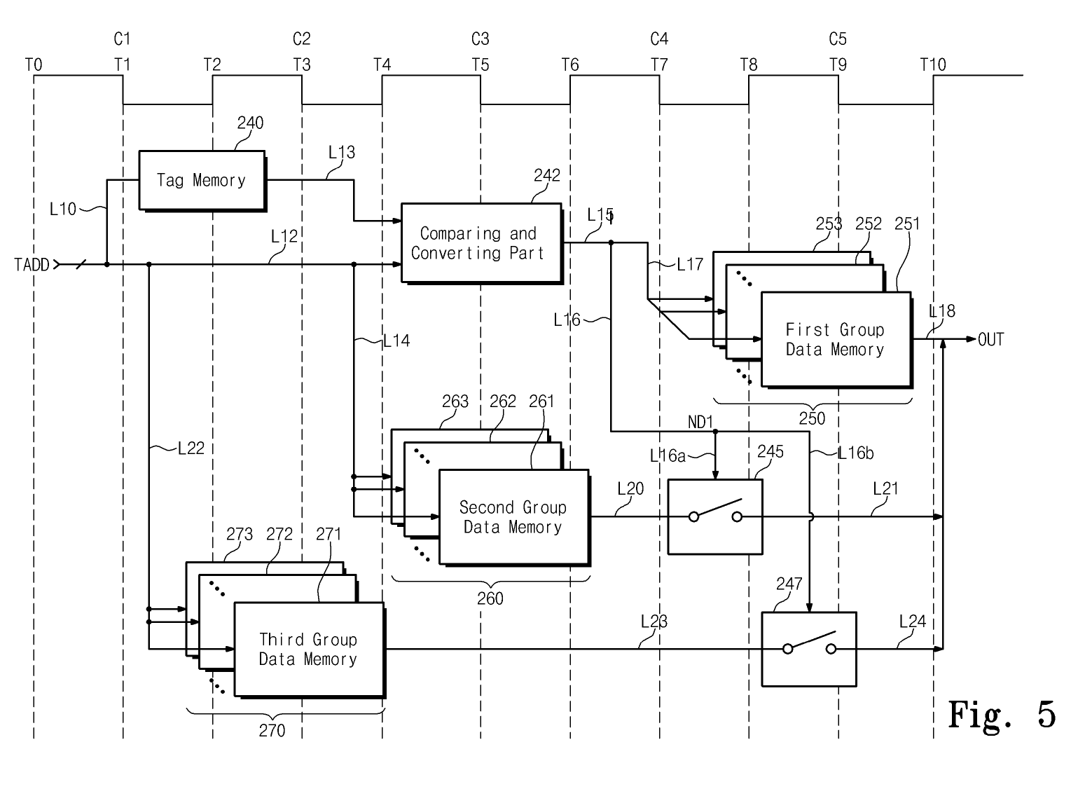

FIG. 5 is a block diagram of a cache memory system according to another exemplary embodiment.

Referring to FIG. 5, a cache memory system may include a third group data memory 270 disposed between lines L22 and L23. The third group data memory 270 may receive a target address TADD from the processor 10 before the second group data memory 260 receives the target address TADD. The second switch 247 may switch target data output from the third group data memory 270 on the line L23 into a line L24, which is connected with a data output terminal OUT, in response to a cache hit/miss signal received via a line L16b. The cache memory system in FIG. 5 may be configured substantially the same as that in FIG. 3 except for the addition of the third group data memory 270 and the second switch 247.

In FIG. 5, a cache memory 24 may include a tag memory 240, a first group data memory 250, a second group data memory 260, and a third group data memory 270. In one embodiment, a third group data memory 270 may be disposed farther from the cache control part 22 than the second group data memory 260. The cache control part 22 may be, for example, a cache controller. In this embodiment, the second group data memory 260 may be disposed farther from the cache control part 22 than the first group data memory 250. Although the third group data memory 270 has the largest latency value (due to its distance from the cache control part 22), an increase in the latency of the cache memory system may be minimized or reduced by sending the third group data memory 270 the target address TADD first.

In one embodiment, the cache memory 24 (including the first, second, and/or third group data memories 250, 260, and 270) may be a unified or a split cache memory. A unified cache memory may store both commands and data, while a split cache memory may be divided into two sub caches to store commands and data independently. The first, second, and/or third group data memories 250, 260, and 270 may each be configured to have different architectures for efficiency of performance based on whether the cache memory is a unified cache memory or a split cache memory.

In one embodiment, the cache memory system of FIG. 5 is divided into three groups, with a cache memory access time of 4 cycles. In one embodiment, a target address is applied differentially to each of the data groups, based upon the latency of each group data memory.

In one embodiment, the comparing and converting part 242 receives tag data and a target address TADD and generates a cache hit/miss signal based on the tag data. The comparing and converting part 242 may send the target address TADD and the cache hit/miss signal to the first group data memory 250 and to the switches 245 and 247. In an embodiment of a cache memory as depicted in FIG. 5, target data can be output from each of the three groups of data memories when the group data memories 250, 260 and 270 receive the target address TADD. In one embodiment, the switches 245 and 247 would use the cache hit/miss signal as a switch control signal. The switches 245 and 247 may remain open unless the cache hit/miss signal indicates a cache hit at either the second group data memory 260 or the third group data memory 270.

In one embodiment, the switch 245 closes when the switch 245 receives a cache hit/miss signal that indicates a cache hit at the second group data memory 260. In this embodiment, the data output on the line L20 from the second group data memory 260 is output via the line L21, and the switch 245 is then set to an open state again. In this embodiment, the switch 247 would remain open since the cache hit/miss signal did not indicate a cache hit at the third group data memory 270.

In one embodiment, the switch 247 closes when the switch 247 receives a cache hit/miss signal that indicates a cache hit at the third group data memory 270. In this embodiment, the data output on the line L23 from the third group data memory 270 is output via the line L24, and the switch 247 is then set to an open state again. In this embodiment, the switch 245 would remain open since the cache hit/miss signal did not indicate a cache hit at the second group data memory 260.

If the cache hit/miss signal indicates a cache hit at the first group data memory 250, the first group data memory 250 outputs target data based on the target address TADD via line L18. If the cache hit/miss signal indicates a cache miss at the first group data memory 250, the first group data memory 250 does not output any target data.

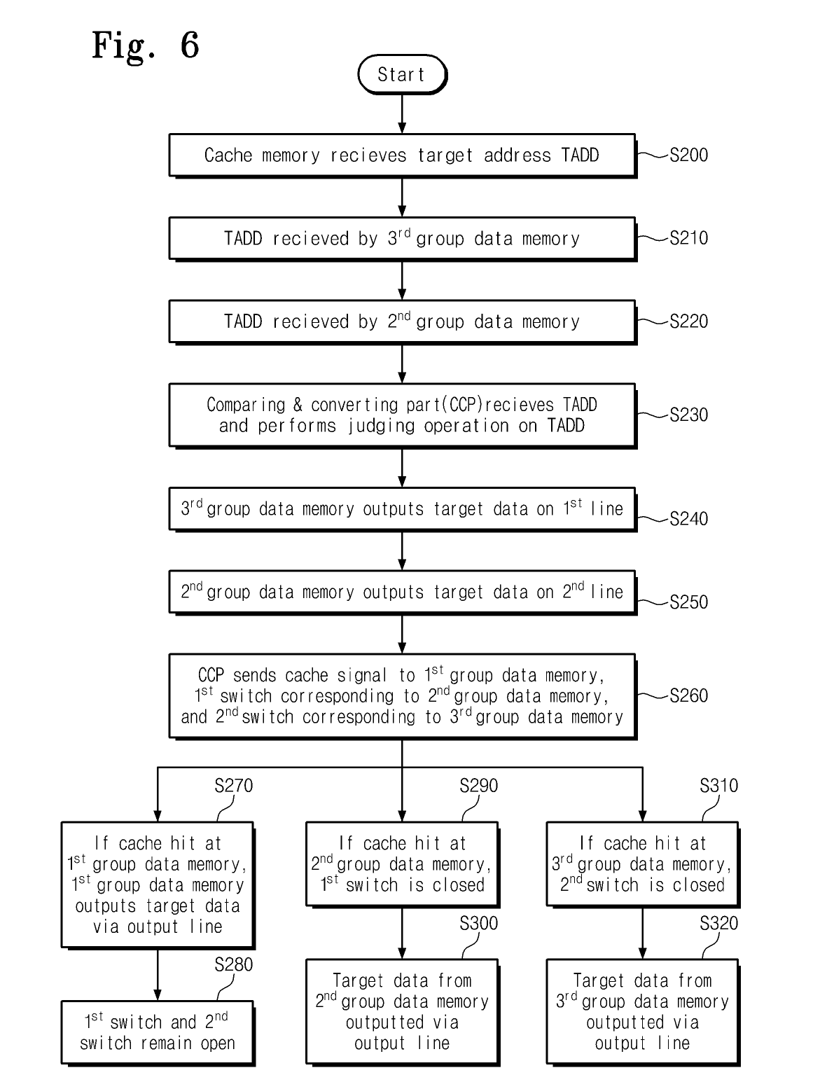

FIG. 6 is a flowchart illustrating an exemplary operation of the cache memory system of FIG. 5. In step S200, the cache memory system receives the target address TADD. In step S210, the TADD is received by the third group data memory 270. In step S220, the TADD is received by the second group data memory 260. In step S230, the comparing and converting part 242 receives the TADD and performs a judging operation on the TADD. In step S240, the third group data memory 270 outputs target data based on the TADD to the line L23. In step S250, the second group data memory 260 outputs target data based on the TADD to the line L20. In one embodiment, steps S230, S240 and S250 may be performed concurrently or in any other order (e.g. step 50 performed before steps S40 and S60). In step S260, the comparing and converting part 242 sends a cache hit/miss signal on lines L15 and L17 to the first group data memory 250, on lines L15 and L16 to the switch 245 corresponding to the second group data memory 260, and on lines L15, L16, and L16b to the switch 247 corresponding to the third group data memory 270.

In step S270, if the cache hit/miss signal indicates a cache hit at the first group data memory 250, the first group data memory 250 outputs target data based on the TADD via line L18 to the output terminal OUT. In step S280, the switches 245 and 247 receive the cache hit/miss signal. In one embodiment, the switches 245 and 247 remain open so that the second group data memory 260 and the third group data memory 270 are not connected to the output terminal OUT. In step S280, the target data output by the second group data memory 260 to line L20 and the target data output by the third group data memory 270 to line L23 is not output to the output terminal OUT. In one embodiment, steps S270 and S280 may be performed concurrently or interchangeably. In step S290, if the cache hit/miss signal indicates a cache hit at the second group data memory 260, the switch 245 is closed and the switch 247 remains open. In step S300, the target data output by the second group data memory 260 to line L20 is output to the output terminal OUT. In step 310, if the cache hit/miss signal indicates a cache hit at the third group data memory 270, the switch 245 remains open and the switch 247 is closed. In step 320, the target data output by the third group data memory 270 to line L23 is output to the output terminal OUT. If the cache hit/miss signal indicates a cache miss at the first group data memory 250, the first group data memory 250 does not output target data based on the target address TADD (not shown).

FIG. 5 also includes a cycle signal waveform diagram for describing the cache memory access time of the cache memory depicted in FIG. 5, according to an exemplary embodiment.

Referring to FIG. 5, 5 latency cycles C1 to C5 are illustrated as a waveform of a cycle signal CS. One cycle may correspond to a system clock frequency signal or to a plurality of clock frequency signals. In one embodiment, the cache memory may apply a target address TADD to each of the group data memories 250, 260, and 270 such that the processing of each group data memory 250, 260, and 270 is finished and target data is output at the same time (e.g. during the same clock cycle). For example, if the latency of the first group data memory 250 is 2, the latency of the second group data memory 260 is 3, and the latency of the third group data memory 270 is 4, the target address TADD may be applied to the third group data memory 270 two clock cycles before it is applied to the first group data memory 250. Similarly, the target address TADD may be applied to the second group data memory 260 one clock cycle before it is applied to the first group data memory 250. In one embodiment, the target address TADD is applied to the second or third group memory data 260 or 270 one or more clock cycles earlier than it would need to be applied for the processing of all three group data memories 250, 260, and 270 to be finished at the same time.

In the embodiment depicted in FIG. 5, the first group data memory 250 may have a latency of 2, the second group data memory 260 may have a latency of 3, and the third group data memory 270 has a latency of 4. In this embodiment, a target address TADD is applied to the first group data memory 250 at t8. In an exemplary cache memory system, the target address TADD is applied to the second and third group data memories 260 and 270 before the first group data memory 250. At t4, the target address TADD may be applied to the second group data memory 260. At t2, the target address TADD may be applied to the third group data memory 270. As mentioned above, the target address TADD is applied to the second and third group data memories 260 and 270 at an early enough time such that their processing is able to end at the same time or before the processing of the first group data memory 250. In this embodiment, the cache memory access time of the cache memory system may be reduced. For example, the cache memory access time of the cache memory system 20 may be reduced to be similar to a latency of a cache memory system that only included the first group data memory 250.

As illustrated in FIG. 5, the architecture of a cache memory system having a large cache memory may be utilized more powerfully. In one embodiment, the large cache memory has a variable cache memory access time that lasts across one or more cycles and latency value based on the physical placements of data memories in the cache memory.

The latency of the first group data memory 250 may be relatively small since it is disposed to be closer to a logic area of a cache control part. In one embodiment, the first group data memory 250 may be associated with a short-distance cache data memory group. Target data from data memories in the short-distance cache data memory group may be obtained after generation and/or output of a cache hit/miss signal.

In one embodiment, the latencies of the second and third group data memories 260 and 270 may be relatively large since they are disposed farther from a logic area of a cache control part. In one embodiment, the second and third group data memories 260 and 270 may be associated with a long-distance cache data memory group. Target data from data memories in the long-distance cache data memory group may be obtained by applying a target address TADD to the data memory in the long-distance cache data memory group before the generation and/or output of a cache hit/miss signal.

In one embodiment, the cache memory access time of the cache memory system may be minimized or reduced by sending a target address to the second and third group data memories 260 and 270 before sending the target address to the first group data memory 250. For example, the target address may be received by the second and third group data memories 260 and 270 before the generation and/or output of a cache hit/miss signal, whereas the target address may be applied to the first group memory 250 after the generation and/or output of the cache hit/miss signal. The differential application of the target address to the different group memories may occur when the second and third group data memories 260 and 270 have a latency larger in value than that of the first group data memory 250. In this embodiment, the cache memory access time of the cache memory system may be minimized or reduced by selectively switching target data output from the second and third group data memories 260 and 270 accessed prior to the first group data memory 250 according to the cache hit/miss signal. This exemplary operation may enable high-speed cache operation and may improve the performance of the cache memory system.

In an example configuration of the cache memory in FIG. 5, the switches 245 and 247 are installed outside the second and third group data memories 260 and 270. As illustrated in FIGS. 7 and 8, the switches 245 and 247 may be replaced with a switching part 130 installed within the second and third group data memories 260 and 270.

FIG. 7 is a block diagram of the second and third group data memories 260 and 270 according to an exemplary embodiment.

Referring to FIG. 7, the second/third group data memory may include a control circuit 100, a memory cell array 110, a row decoder 120, a column decoder 140, and a sense amplifier 150. A switching part 130 may be disposed between the memory cell array 110 and the column decoder 140 to switch target data in response to a cache hit/miss signal received via a line L16. A target address may be applied via the output terminal OUT to a data line L14 connected with the control circuit 100. The memory cell array 110 may be formed of a plurality of static random access memory cells which are arranged in plural rows and plural columns.

If the switching part 130 is disposed as illustrated in FIG. 7, target data may not be output via the sense amplifier 150 if the switching part 130 includes an open switch. In one embodiment, if a cache hit/miss signal transmitted on the line L16 indicates a cache miss at second and third group data memories 260 and 270, the switching part 130 may remain open. As a result, the column decoding operation of the column decoder 140 is disabled because it is not connected to the memory cell array 110. Target data from the memory cell array 110 may then not be output via the sense amplifier 150.

FIG. 8 is a block diagram of the second and third group data memories 260 and 270 according to another exemplary embodiment.

Referring to FIG. 8, the second/third group data memory may include a control circuit 100, a memory cell array 110, a row decoder 120, a column decoder 140, and a sense amplifier 150. A switching part 130 may be disposed between the memory cell array 110 and the row decoder 120 to switch target data in response to a cache hit/miss signal received via a line L16. A target address may be applied via an output terminal OUT to a data line L14 connected with the control circuit 100. The memory cell array 110 may be formed of a plurality of static random access memory cells which are arranged in plural rows and plural columns.

If the switching part 130 is disposed within a memory as illustrated in FIG. 8, no word line of the memory cell array 110 may be selected since a row decoding operation of the row decoder 120 may be disabled at switching-off. In one embodiment, if a cache hit/miss signal is transmitted on the line L16 and the cache hit/miss signal indicates a cache miss at the second and third group data memories 260 and 270, the switching part 130 may remain open. As a result, the row decoding operation of the row decoder 140 is disabled because it is not connected to the memory cell array 110 and no word line of the memory cell array 110 may be selected. Correspondingly, target data from the memory cell array 110 may not be output via the sense amplifier 150.

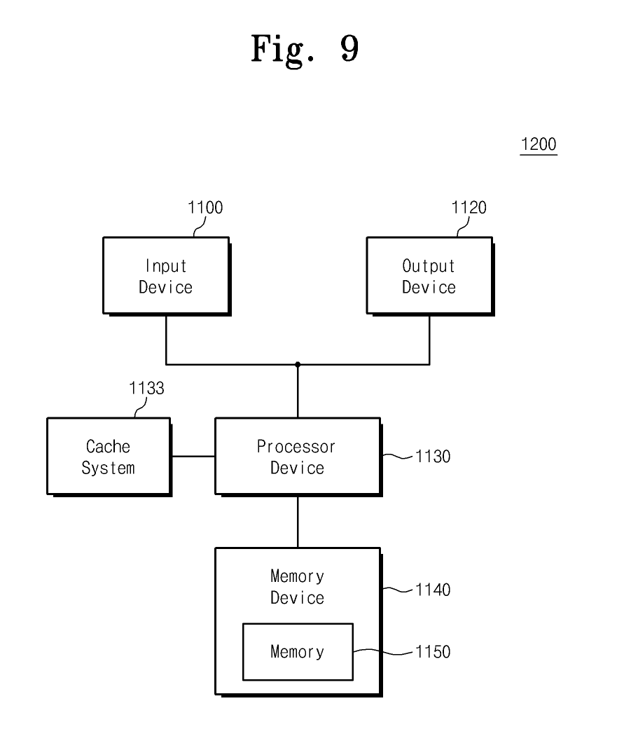

FIG. 9 is a block diagram of an electronic system 1200 according to an exemplary embodiment. Referring to FIG. 9, an electronic system 1200 may include an input device 1100, an output device 1120, a processor device 1130, a cache system 1133, and a memory device 1140.

In FIG. 9, the memory device 1140 may include a DRAM 1150. The processor device 1130 may control the input device 1100, the output device 1120, and the memory device 1140 via corresponding interfaces, respectively. If the processor device 1130 utilizes the cache system 1133 as described in the preceding Figures, an increase in cache latency may be minimized or reduced, so that the performance of the electronic system 1200 is improved.

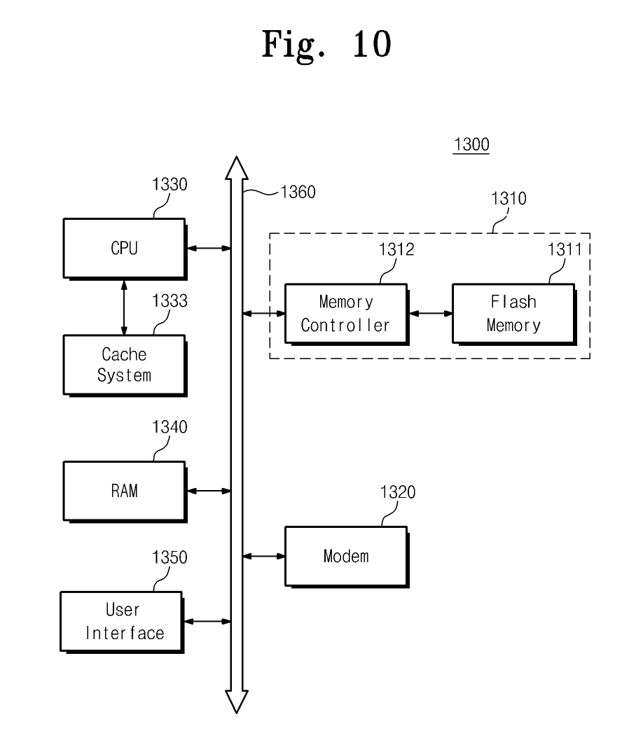

FIG. 10 is a block diagram of a data processing device 1300 according to an exemplary embodiment. Referring to FIG. 10, an exemplary cache system 1333 may be applied to a data processing device 1300. The data processing device 1300 may be, for example, a mobile device or a desktop computer. The data processing device 1300 may further include a flash memory system 1310, a modem 1320, a CPU 1330, a RAM 1340, and a user interface 1350 which are connected to a system bus 1360. The flash memory system 1310 may include a memory controller 1312 and a flash memory 1311. Data processed by the CPU 1330 or received from an external source may be stored in the flash memory system 1310. In one embodiment, the flash memory system 1310 is formed of a solid state drive (SSD) device. In one embodiment, the data processing system 1300 may store mass data stably in the flash memory system 1310. With an increase in reliability, the flash memory system 1310 may be capable of reducing resources needed for error correction and may provide a high-speed data exchange function to the data processing device 1300. Although not illustrated in FIG. 10, the data processing device 1300 may further include an application chipset, a camera image processor (CIS), an input/output device, and the like.

In one embodiment, a cache system 1333 or a flash memory system 1310 may be packed by various packages, such as PoP (Package on Package), Ball grid arrays (BGAs), Chip scale packages (CSPs), Plastic Leaded Chip Carrier (PLCC), Plastic Dual In-Line Package (PDIP), Die in Waffle Pack, Die in Wafer Form, Chip On Board (COB), Ceramic Dual In-Line Package (CERDIP), Plastic Metric Quad Flat Pack (MQFP), Thin Quad Flatpack (TQFP), Small

Outline (SOIC), Shrink Small Outline Package (SSOP), Thin Small Outline (TSOP), Thin Quad Flatpack (TQFP), System In Package (SIP), Multi Chip Package (MCP), Wafer-level Fabricated Package (WFP), Wafer-Level Processed Stack Package (WSP), and the like.

If the CPU 1330 utilizes the cache system 1333 as described in the preceding Figures, an increase in cache latency may be minimized or reduced, so that the performance of the electronic system is improved.

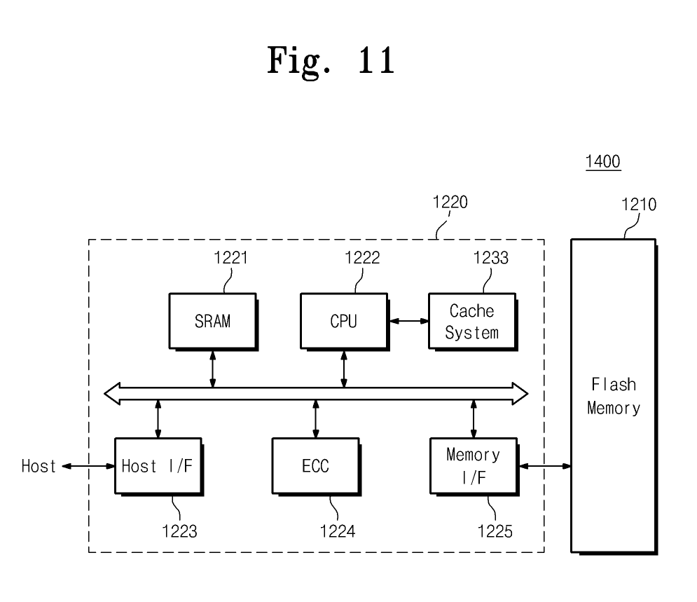

FIG. 11 is a block diagram of a memory card 1400 according to an exemplary embodiment. Referring to FIG. 11, a memory card 1400 for supporting a large data storage capacity may include an exemplary cache system 1233. The memory card 1400 may include a memory controller 1220 which controls data exchange between a host and a flash memory 1210 overall.

The memory controller 1220 may include an SRAM 1221 which is used as a working memory of a CPU 1222. A host interface 1223 may provide a data exchange interface between the memory card 1400 and a host. An ECC block 1224 may detect and correct errors of data read from the flash memory 1210. The memory interface 1225 may provide a data exchange interface between the CPU 1222 and the flash memory 1210. The CPU 1222 may control an overall operation associated with data exchange of the memory controller 1220. Although not shown in FIG. 11, the memory card 1400 adopting the cache system 1133 may further include a ROM which stores code data for an interface with the host.

If the memory card 1400 utilizes the cache system 1233 as described in the preceding Figures, an increase in cache latency may be minimized or reduced, so that a data processing speed of CPU is improved. Accordingly, the performance of a memory card 1400 adopting the cache system 1233 may be improved.

In an exemplary cache memory system, it may be possible to minimize or reduce cache latency and to differently determine an applying time of a tag address according to a latency value of a data memory. In one embodiment, a cache memory system may be provided which has a data memory accessed by a tag address before cache hit/miss is judged. In one embodiment, a data memory within a data memory group having relatively large latency may be accessed before a data memory within a data memory group having relatively small latency is accessed. In one embodiment, it may be possible to perform a cache operation in a high speed.

The above-disclosed subject matter is to be considered illustrative, and not restrictive, and the appended claims are intended to cover all such modifications, enhancements, and other embodiments, which fall within the true spirit and scope of the disclosed embodiments. Thus, the invention is to be determined by the broadest permissible interpretation of the following claims and their equivalents, and shall not be restricted or limited by the foregoing detailed description.

What is claimed is:

1. A cache memory controlling method for reducing cache latency, comprising the steps of:
receiving, by a first memory storing tag data, a target address;
generating and outputting a cache signal based on the target address, the cache signal indicating whether a first group data memory stores a target data corresponding to the target address and indicating whether a second group data memory stores the target data;
receiving the target address at the second group data memory before the cache signal is output, and
outputting to a first line, by the second group data memory, a second group target data based on the target address,
wherein the second group data memory has a latency larger than that of the first group data memory.

2. The method of claim 1, further comprising the steps of:
receiving, by a first switch corresponding to the second group data memory, the cache signal and the second group target data output to the first line; and
controlling the first switch to output the second group target data to an output line based on the cache signal.

3. The method of claim 2, further comprising the steps of:
when the cache signal indicates a cache hit at the second group data memory:
setting the first switch to a closed state; and
outputting the second group target data to the output line.

4. The method of claim 2, wherein the first switch is disposed between a memory cell array and a column decoder of the first group data memory.

5. The method of claim 1, further comprising the steps of:
receiving, by the first group data memory, the cache signal;
when the cache signal indicates a cache hit at the first group data memory:
outputting to an output line, by the first group data memory, a first group target data based on the target address.

6. The method of claim 1, further comprising the steps of:
receiving, by a first switch that corresponds to the second group data memory, the cache signal;
when the cache signal indicates a cache miss at the second group data memory:
setting the first switch to an open state.

7. The method of claim 1,
wherein the cache signal comprises a set of one or more bits, and
wherein the indication of whether the first group data memory stores the target data and the indication of whether the second group target data stores the target data are included in the set of bits.

8. The method of claim 1, further comprising the steps of:
receiving the target address at a third group data memory before the cache signal is output; and
outputting to a second line, by the third group data memory, a third group target data based on the target address,
wherein the third group data memory has a latency larger than that of the second group data memory, and
wherein the cache signal indicates whether the third group data memory stores the target data.

9. The method of claim 8, further comprising the steps of:
receiving, by a second switch corresponding to the third group data memory, the cache signal and the third group target data output to the second line; and
controlling the switch to output the third group target data to an output line based on the cache signal.

10. The method of claim 9, further comprising the steps of:
when the cache signal indicates a cache hit at the third group data memory:
setting the second switch to a closed state;
setting the first switch in an open state; and
outputting the third group target data to the output line.

11. A cache memory system comprising:
a cache memory comprising:
at least a first group data memory,
at least a second group data memory, and
a switch configured to receive a second group target data from the second group data memory and to control whether to output the second group target data to an output line based on a cache signal; and
a cache controller configured to :
compare a target address to tag data; and
generate the cache signal based on the comparison, the cache signal indicating whether the first group data memory stores a target data corresponding to the target address and indicating whether the second group data memory stores the target data.

12. The system of claim 11, wherein the first group data memory is configured to:
receive the cache signal and the target address, and
when the cache signal indicates a hit at the first group data memory, output a first group target data based on the target address to the output line.

13. The system of claim 11, wherein the first group data memory is disposed closer to the cache controller than the second group data memory.

14. The system of claim 11, wherein the second group data memory is configured to receive the target address before the switch receives the cache signal.

15. The system of claim 11, wherein the switch is disposed between a memory cell array and a column decoder of the second group data memory.

16. The system of claim 11, wherein the switch is disposed between a memory cell array and a row decoder of the second group data memory.

17. A method for reducing cache latency in a cache memory, comprising the steps of:
receiving, by a first memory, a target address;
generating and outputting a cache signal based on the target address, the cache signal indicating whether a first group data memory includes a target data corresponding to the target address and indicating whether a second group data memory includes the target data;
receiving the target address at a second group data memory before the cache signal is output; and
outputting to a first line, by the second group data memory, a second group target data based on the target address,
wherein the second group data memory is situated farther from a cache controller than the first group data memory.

18. The method of claim 17, further comprising the steps of:
receiving, by a switch corresponding to the second group data memory, the cache signal and the second group target data output to the first line;
when the cache signal indicates a cache hit at the second group data memory:
setting the switch to a closed state; and
outputting the second group target data to an output line.

19. The method of claim 18, wherein the switch is disposed between a memory cell array and a row decoder of the second group data memory.

20. The method of claim 17, further comprising the steps of:
when the cache signal indicates a cache hit at the first group data memory:
outputting to an output line, by the first group data memory, a first target data based on the target address; and
setting a switch corresponding to the second group data memory to an open state.
